(19) United States
(12) Patent Application Publication
(10) Pub. No.: US 2019/0379519 A1
(43) Pub. Date: Dec. 12, 2019

(54) CONFIRMATION APPARATUS FOR ACTIVATION COMMAND, REPORT APPARATUS FOR DATA TRANSMISSION MODE AND METHODS THEREOF

(71) Applicant: FUJITSU LIMITED, Kawasaki-shi (JP)

(72) Inventors: Yulong SHI, Beijing (CN); Meiyi JIA, Beijing (CN); Hua ZHOU, Beijing (CN)

(73) Assignee: FUJITSU LIMITED, Kawasaki-shi (JP)

(21) Appl. No.: 16/547,012

(22) Filed: Aug. 21, 2019

Related U.S. Application Data
(63) Continuation of application No. PCT/CN2017/083309, filed on May 5, 2017.

(51) Int. Cl. H04L 5/00; H04L 1/18; H04W 80/02; H04W 80/08; H04W 28/02

(52) U.S. Cl. CPC H04L 5/0098; H04L 1/1896; H04W 28/0278; H04W 80/08; H04W 80/02

(57) ABSTRACT

The confirmation apparatus for an activation command includes: a first transmitting unit configured to transmit confirmation information on an activation command or deactivation command of a duplication transmission mode to network equipment when receiving the activation command or deactivation command of a duplication transmission mode. By transmitting the confirmation information on an activation command or deactivation command of a duplication transmission mode to network equipment, or transmitting information on a current data transmission mode of a data transmission entity of user equipment to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, ensuring reliability of the data transmission and rationality of the resource allocation.

### CROSS REFERENCE TO RELATED APPLICATIONS

This application is a continuation application of International Application PCT/CN2017/083309 filed on May 5, 2017, the entire contents of which are incorporated herein by reference.

### TECHNICAL FIELD

This disclosure relates to the field of communications technologies, and in particular to a confirmation apparatus for an activation command, a report apparatus for a data transmission mode and methods thereof.

### BACKGROUND

At present, when a network equipment (such as a base station) and a user equipment (UE) perform data transmission, a data transmitting entity may adopt a split transmission mode, that is, transmitting different data on different links. For example, in transmitting PDCP (packet data convergence protocol) data, different PDCP PDUs (protocol data units) may be transmitted on different links.

Subjects related to next-generation wireless communications systems are under study in the 3rd Generation Partnership Project (3GPP). In order to support data transmission of high reliability, duplication transmission mode of data will be supported in the next generation systems, that is, transmitting identical data on different links. For example, duplication transmission of PDCP data (PDCP PDUs) on a plurality of links is transmitting identical PDCP PDUs on different links. By using diversity gains of transmission of identical data on a plurality of different links, error probabilities of data transmission may be lowered, and the reliabilities of services may be ensured.

Resource utilization of duplication transmission is low relative to the split transmission. For example, when two different links are used to transmit identical data in the duplication transmission mode, resource utilization of the duplication transmission mode is only half of the split transmission mode. A large amount of radio resources are sacrificed in the duplication transmission mode, so as to improve reliabilities of data transmission. Hence, when quality of the radio links is good and the split transmission mode may satisfy the reliabilities of the data transmission, it is needed to deactivate the duplication transmission mode and adopt the split transmission mode. And when the quality of the radio link deteriorates, in order to ensure the reliabilities of data transmission, it is needed to activate the duplication transmission mode. And the network equipment may configure a data transmission mode for the user equipment according to the quality of current radio link and demands of services, i.e. activating or deactivating the duplication transmission mode.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that when the quality of the radio link deteriorates, the network equipment transmits a command to activate the duplication transmission mode to the user equipment. When the user equipment does not successfully receive the command, the user equipment still uses the split transmission mode for data transmission, hence, reliability of services cannot be guaranteed. When the quality of the radio link is good and the split transmission mode can satisfy the reliability of the data transmission, the network equipment transmits a command to deactivate the duplication transmission mode to the user equipment, when the user equipment does not successfully receive the command, the user equipment still uses the duplication transmission mode for data transmission, thereby resulting in relatively low resource utilization.

Furthermore, it was also found by the inventors that buffer state calculation methods and report methods of the duplication transmission mode and the split transmission mode are completely identical, and the network equipment needs to allocate different numbers of radio resources according to the data transmission mode used by the user equipment. When the command transmitted by the network equipment to activate or deactivate the duplication transmission mode is not correctly received by the user equipment, a problem of unmatch of the data transmission mode configuration of the network equipment and the user equipment may be resulted in. At this time, when the network equipment allocates resources according to the buffer status report of the user equipment, there may occur a problem that the resources allocated are too many or too few.

Embodiments of this disclosure provide a confirmation apparatus for an activation command, a report apparatus for a data transmission mode and methods thereof, in which the network equipment is able to confirm a current data transmission mode of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

According to a first aspect of the embodiments of this disclosure, there is provided a confirmation apparatus for an activation command, including: a first transmitting unit configured to transmit confirmation information on an activation command or deactivation command of a duplication transmission mode to a network equipment when receiving the activation command or deactivation command of the duplication transmission mode.

According to a second aspect of the embodiments of this disclosure, there is provided a report apparatus for a data transmission mode, including: a second transmitting unit configured to transmit information on a current data transmission mode of a data transmission entity of a user equipment to a network equipment.

According to a third aspect of the embodiments of this disclosure, there is provided a user equipment, including the confirmation apparatus for an activation command as described in the first aspect of the embodiments of this disclosure or the report apparatus for a data transmission mode as described in the second aspect of the embodiments of this disclosure.

According to a fourth aspect of the embodiments of this disclosure, there is provided a confirmation apparatus for an activation command, including: a first receiving unit configured to receive confirmation information on an activation command or deactivation command of a duplication transmission mode transmitted by a terminal equipment.

According to a fifth aspect of the embodiments of this disclosure, there is provided a confirmation apparatus for an activation command, including: a fourth transmitting unit configured to retransmit an activation command or deactivation command of a duplication transmission mode to a terminal equipment when no confirmation information on an activation command or deactivation command of the duplication transmission mode transmitted by the terminal equipment is received within a predetermined period of time for transmitting the activation command or deactivation command of the duplication transmission mode.

According to a sixth aspect of the embodiments of this disclosure, there is provided a network equipment, including the confirmation apparatus for an activation command as described in the fourth or the fifth aspect of the embodiments of this disclosure.

According to a seventh aspect of the embodiments of this disclosure, there is provided a communications system, including the user equipment as described in the third aspect of the embodiments of this disclosure and the network equipment as described in the sixth aspect of the embodiments of this disclosure.

According to an eighth aspect of the embodiments of this disclosure, there is provided a confirmation method for an activation command, including: transmitting confirmation information on an activation command or deactivation command of a duplication transmission mode to a network equipment when receiving the activation command or deactivation command of the duplication transmission mode.

According to a ninth aspect of the embodiments of this disclosure, there is provided a report method for a data transmission mode, including: transmitting information on a current data transmission mode of a data transmission entity of a user equipment to a network equipment.

According to a tenth aspect of the embodiments of this disclosure, there is provided a confirmation method for an activation command, including: receiving confirmation information on an activation command or deactivation command of a duplication transmission mode transmitted by a user equipment.

According to an eleventh aspect of the embodiments of this disclosure, there is provided a confirmation method for an activation command, including: retransmitting an activation command or deactivation command of a duplication transmission mode to a user equipment when no confirmation information on an activation command or deactivation command of the duplication transmission mode transmitted by the user equipment is received within a predetermined period of time for transmitting the activation command or deactivation command of the duplication transmission mode.

According to a twelfth aspect of the embodiments of this disclosure, there is provided a computer readable program, which, when executed in a confirmation apparatus for an activation command or a user equipment, may cause the confirmation apparatus for an activation command or the user equipment to carry out the confirmation method for an activation command as described in the eighth aspect of the embodiments of this disclosure.

According to a thirteenth aspect of the embodiments of this disclosure, there is provided a computer storage medium, including a computer readable program, which may cause a confirmation apparatus for an activation command or a user equipment to carry out the confirmation method for an activation command as described in the eight aspect of the embodiments of this disclosure.

According to a fourteenth aspect of the embodiments of this disclosure, there is provided a computer readable program, which, when executed in a report apparatus for a data transmission mode or a user equipment, may cause the report apparatus for a data transmission mode or the user equipment to carry out the report method for a data transmission mode as described in the ninth aspect of the embodiments of this disclosure.

According to a fifteenth aspect of the embodiments of this disclosure, there is provided a computer storage medium, including a computer readable program, which may cause a report apparatus for a data transmission mode or a user equipment to carry out the report method for a data transmission mode as described in the ninth aspect of the embodiments of this disclosure.

According to a sixteenth aspect of the embodiments of this disclosure, there is provided a computer readable program, which, when executed in a confirmation apparatus for an activation command or a network equipment, may cause the confirmation apparatus for an activation command or the network equipment to carry out the confirmation method for an activation command as described in the tenth or the eleventh aspect of the embodiments of this disclosure.

According to a seventeenth aspect of the embodiments of this disclosure, there is provided a computer storage medium, including a computer readable program, which may cause a confirmation apparatus for an activation command or a network equipment to carry out the confirmation method for an activation command as described in the tenth or the eleventh aspect of the embodiments of this disclosure.

An advantage of the embodiments of this disclosure exists in that by transmitting the confirmation information on an activation command or deactivation command of a duplication transmission mode to network equipment, or transmitting information on a current data transmission mode of a data transmission entity of user equipment to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a communications system of an embodiment of this disclosure;

FIG. 2 is a schematic diagram of the confirmation method for an activation command of Embodiment 1 of this disclosure;

FIG. 3 is a schematic diagram of a method for receiving an activation command of a duplication transmission mode and transmitting a confirmation message of Embodiment 1 of this disclosure;

FIG. 4 is a schematic diagram of a method for receiving a deactivation command of a duplication transmission mode and transmitting a confirmation message of Embodiment 1 of this disclosure;

FIG. 5 is a schematic diagram of an MAC CE used for transmitting confirmation information of Embodiment 1 of this disclosure;

FIG. 6 is another schematic diagram of the MAC CE used for transmitting confirmation information of Embodiment 1 of this disclosure;

FIG. 7 is a schematic diagram of the PDCP PDU of Embodiment 1 of this disclosure;

FIG. 8 is another schematic diagram of the PDCP PDU of Embodiment 1 of this disclosure;

FIG. 9 is a schematic diagram of the report method for a data transmission mode of Embodiment 2 of this disclosure;

FIG. 10 is a schematic diagram of the confirmation method for an activation command of Embodiment 3 of this disclosure;

FIG. 11 is another schematic diagram of the confirmation method for an activation command of Embodiment 3 of this disclosure;

FIG. 12 is a schematic diagram of the confirmation method for an activation command of Embodiment 4 of this disclosure;

FIG. 13 is a schematic diagram of the confirmation method for an activation command of Embodiment 5 of this disclosure;

FIG. 14 is a schematic diagram of the confirmation method for an activation command of Embodiment 6 of this disclosure;

FIG. 15 is a schematic diagram of the confirmation apparatus for an activation command of Embodiment 7 of this disclosure;

FIG. 16 is a schematic diagram of the report apparatus for a data transmission mode of Embodiment 8 of this disclosure;

FIG. 17 is a schematic diagram of the confirmation apparatus for an activation command of Embodiment 9 of this disclosure;

FIG. 18 is a schematic diagram of the confirmation apparatus for an activation command of Embodiment 10 of this disclosure;

FIG. 19 is a block diagram of a systematic structure of the user equipment of Embodiment 11 of this disclosure;

FIG. 20 is a block diagram of a systematic structure of the user equipment of Embodiment 12 of this disclosure;

FIG. 21 is a block diagram of a structure of the network equipment of Embodiment 13 of this disclosure; and

FIG. 22 is a block diagram of a structure of the network equipment of Embodiment 14 of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communications network” or “wireless communications network” may refer to a network satisfying any one of the following communications standards: long term evolution (LTE), long term evolution-advanced (LTE-A), wideband code division multiple access (WCDMA), and high-speed packet access (HSPA), etc.

And communications between devices in a communications system may be performed according to communications protocols at any stage, which may, for example, include but not limited to the following communications protocols: 1G (generation), 2G, 2.5G, 2.75G, 3G, 4G, 4.5G, and 5G and new radio (NR) in the future, and/or other communications protocols that are currently known or will be developed in the future.

In the embodiments of this disclosure, the term “network equipment”, for example, refers to a device in a communications system that accesses a user equipment to the communications network and provides services for the user equipment. The network equipment may include but not limited to the following devices: a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico). The term “base station” may include some or all of its functions, and each base station may provide communications coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, equipment accessing to a communications network and receiving network services via a network device. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communications device, a hand-held device, a machine-type communications device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communications (MTC) terminal, a vehicle mounted communications terminal, a device to device (D2D) terminal, and a machine to machine (M2M) terminal.

The embodiments of this disclosure may be applicable to various types of data transmission, and shall be described by taking transmission of PDCP PDUs as examples; however, the embodiments of this disclosure are not limited thereto.

Scenarios in the embodiments of this disclosure shall be described below by way of examples; however, the embodiments of this disclosure are not limited thereto.

FIG. 1 is a schematic diagram of a communications system of an embodiment of this disclosure, in which a case where a user equipment and a network equipment are taken as examples is schematically shown. As shown in FIG. 1, a communications system 100 may include a network equipment 101 and a user equipment 102 (for the sake of simplicity, FIG. 1 shall be described by taking only one user equipment as an example).

In the embodiment of this disclosure, existing traffics or traffics that may be implemented in the future may be performed between the network equipment 101 and the user equipment 102. For example, such traffics may include but not limited to an enhanced mobile broadband (eMBB), massive machine type communications (MTC), and ultra-reliable and low-latency communications (URLLC).

### Embodiment 1

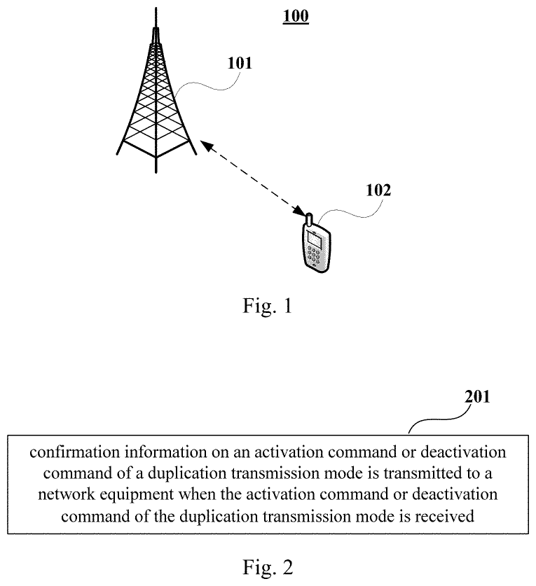

The embodiment of this disclosure provides a confirmation method for an activation command, applicable to a user equipment side. FIG. 2 is a schematic diagram of the confirmation method for an activation command of Embodiment 1 of this disclosure. As shown in FIG. 2, the method includes:

Step 201: confirmation information on an activation command or deactivation command of a duplication transmission mode is transmitted to a network equipment when the activation command or deactivation command of the duplication transmission mode is received.

In this embodiment, when the user equipment and the network equipment perform data transmission, a data transmission entity may adopt a plurality of data transmission modes including a duplication transmission mode, for example, the data transmission mode may also be a split transmission mode. For example, the duplication transmission mode refers to transmitting identical data on different links, and the split transmission mode refers to transmitting different data on different links.

In this embodiment, when the data transmission entity of the user equipment performs data transmission, its default data transmission mode may be, for example, the split transmission mode, in which case the network equipment may configure a data transmission mode of the data transmission entity of the user equipment according to the current radio link quality and service requirements, that is, activate or deactivate the duplication transmission mode.

In this embodiment, the data transmission entity may be various entities in the user equipment, such as a PDCP entity.

In this embodiment, the user equipment may perform various types of data transmission, and the data transmission entity may be various types of entities in the user equipment. Following description shall be given by taking that a PDCP entity of the user equipment is the data transmission entity and received commands are an activation command and a deactivation command respectively in the duplication transmission mode as examples.

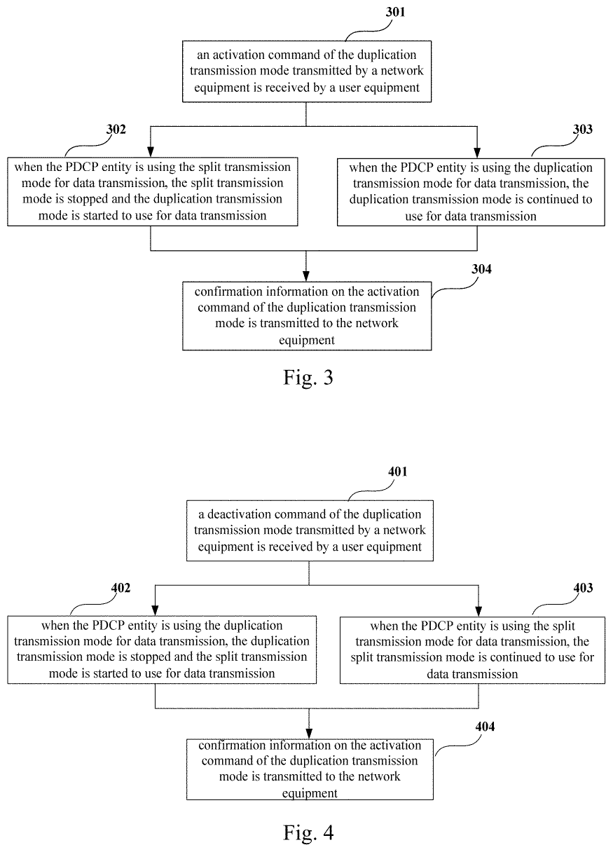

FIG. 3 is a schematic diagram of a method for receiving an activation command of a duplication transmission mode and transmitting a confirmation message of Embodiment 1 of this disclosure. As shown in FIG. 3, the method includes:

Step 301: an activation command of the duplication transmission mode transmitted by a network equipment is received by a user equipment;

Step 302: when the PDCP entity is using the split transmission mode for data transmission, the split transmission mode is stopped and the duplication transmission mode is started to use for data transmission;

Step 303: when the PDCP entity is using the duplication transmission mode for data transmission, the duplication transmission mode is continued to use for data transmission; and

Step 304: confirmation information on the activation command of the duplication transmission mode is transmitted to the network equipment.

FIG. 4 is a schematic diagram of a method for receiving a deactivation command of a duplication transmission mode and transmitting a confirmation message of Embodiment 1 of this disclosure. As shown in FIG. 4, the method includes:

Step 401: a deactivation command of the duplication transmission mode transmitted by a network equipment is received by a user equipment;

Step 402: when the PDCP entity is using the duplication transmission mode for data transmission, the duplication transmission mode is stopped and the split transmission mode is started to use for data transmission;

Step 403: when the PDCP entity is using the split transmission mode for data transmission, the split transmission mode is continued to use for data transmission; and

Step 404: confirmation information on the activation command of the duplication transmission mode is transmitted to the network equipment.

In this embodiment, the above step 304 and the step 302 or 303 may be performed simultaneously, or may be performed sequentially. Similarly, the above step 404 and the step 402 or 403 may be performed simultaneously or sequentially. An order of execution of these steps is not limited in the embodiment of this disclosure.

In this embodiment, the user equipment may transmit the confirmation information in various ways. For example, the confirmation information on an activation command or deactivation command of a duplication transmission mode may be transmitted to the network equipment via a control element (CE) of a media access control (MAC) layer.

For example, the user equipment may transmit the confirmation information via a specific MAC CE, such as transmitting the confirmation information via a duplication confirmation MAC control element.

In this embodiment, the MAC CE used for transmitting the confirmation information may be determined by, for example, a separately defined LCID (logical channel identity) in a subheader in its corresponding MAC PDU.

In this embodiment, the MAC CE may indicate that the activation command or the deactivation command of the duplication transmission mode is received, and may also indicate, in a bit mapping manner, whether at least one data transmission entity of the user equipment is successfully activated or deactivated with the duplication transmission mode, or denotes a current data transmission mode of at least one data transmission entity of the user equipment, which shall be respectively illustrated below.

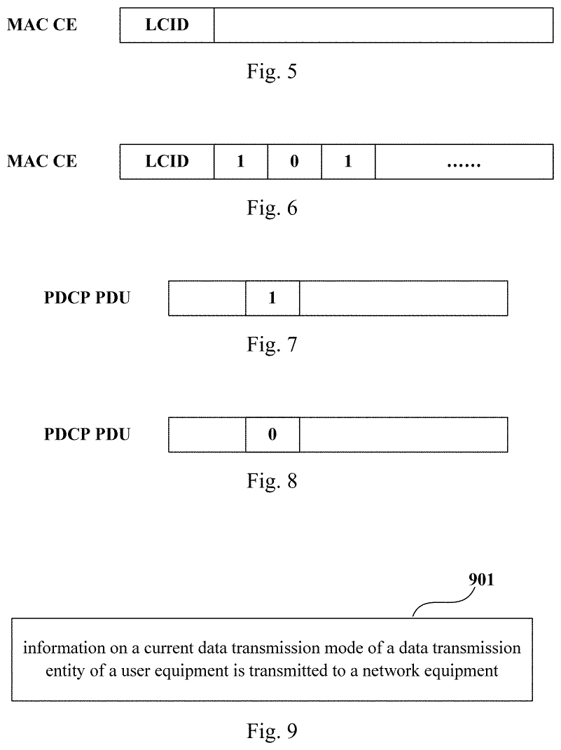

FIG. 5 is a schematic diagram of an MAC CE used for transmitting confirmation information of Embodiment 1 of this disclosure. As shown in FIG. 5, the MAC CE includes a heading LCD, and the following content may be blank. When the network equipment receives the MAC CE, it indicates that the user equipment has received the activation command or the deactivation command of the duplication transmission mode.

In this embodiment, for example, a value of at least one bit in a specific field of the MAC CE indicates whether the current data transmission mode of the at least one data transmitting entity of the user equipment to which the at least one bit corresponds is a duplication transmission mode or a split transmission mode. FIG. 6 is another schematic diagram of the MAC CE used for transmitting confirmation information of Embodiment 1 of this disclosure. As shown in FIG. 6, the MAC CE includes a heading LCID, and a plurality of bits in the specific field respectively correspond to a plurality of PDCP entities of the user equipment taken as data transmitting entities. For example, when a value of a bit is set to be “1”, it indicates that the duplication transmission mode is successfully activated for a PDCP entity to which it corresponds, or indicates that a current data transmission mode of a PDCP entity to which it corresponds is the duplication transmission mode; and when a value of a bit is set to be “0”, it indicates that the duplication transmission mode is successfully deactivated for a PDCP entity to which it corresponds, or indicates that a current data transmission mode of a PDCP entity to which it corresponds is the split transmission mode.

In this embodiment, the structure of the MAC CE shown in FIG. 5 and FIG. 6 is exemplary only, and a position and length of a field in the MAC CE are not limited in the embodiment of this disclosure.

In this embodiment, the user equipment may further transmit the confirmation information on the activation command or the deactivation command of the duplication transmission mode to the network equipment by using a protocol data unit of a packet data convergence protocol (PDCP PDU). For example, a specific field of the protocol data unit of the packet data convergence protocol denotes whether a data transmission entity of a user equipment is successfully activated or deactivated with a duplication transmission mode, or denotes whether a current data transmission mode of a data transmission entity of a user equipment is a duplication transmission mode or a split transmission mode.

Following description shall be given by taking that the PDCP entity is used as the data transmission entity as an example. For example, a specific field in the PDCP PDU denotes whether the PDCP entity transmitting the PDCP PDU is successfully activated or deactivated with a duplication transmission mode, or whether a current data transmission mode of the PDCP entity transmitting the PDCP PDU is a duplication transmission mode or a split transmission mode.

FIG. 7 is a schematic diagram of the PDCP PDU of Embodiment 1 of this disclosure, and FIG. 8 is another schematic diagram of the PDCP PDU of Embodiment 1 of this disclosure. As shown in FIGS. 7 and 8, when a specific field in the PDCP PDU is set to be “1”, it indicates that the PDCP entity transmitting the PDCP PDU is successfully activated with the duplication transmission mode, or indicates that a current data transmission mode of the DCP entity transmitting the PDCP PDU is a duplication transmission mode; and when a specific field in the PDCP PDU is set to be “0”, it indicates that the PDCP entity transmitting the PDCP PDU is successfully deactivated with the duplication transmission mode, or indicates that a current data transmission mode of the DCP entity transmitting the PDCP PDU is a split transmission mode.

In this embodiment, the structure of the PDCP PDU shown in FIGS. 7 and 8 is illustrative only, and a position and length of a field in the PDCP PDU are not limited in the embodiment of this disclosure.

It can be seen from the above embodiment that by transmitting the confirmation information on an activation command or deactivation command of a duplication transmission mode to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 2

The embodiment of this disclosure provides a report method for a data transmission mode, applicable to a user equipment side. FIG. 9 is a schematic diagram of the report method for a data transmission mode of Embodiment 2 of this disclosure. As shown in FIG. 9, the method includes:

Step 901: information on a current data transmission mode of a data transmission entity of a user equipment is transmitted to a network equipment.

In this embodiment, when the user equipment and the network equipment perform data transmission, the data transmission entity may employ a plurality of data transmission modes. For example, the data transmission mode may be a duplication transmission mode or a split transmission mode. For example, the duplication transmission mode refers to transmitting identical data on different links, and the split transmission mode refers to transmitting different data on different links. And furthermore, the data transmission mode may be another transmission mode.

For example, the information indicative of the current data transmission mode of the data transmission entity of the user equipment indicates whether the current data transmission mode of the data transmission entity of the user equipment is the duplication transmission mode or the split transmission mode.

In this embodiment, the user equipment may perform various types of data transmission, and the data transmission entity may be, for example, various types of entities in the user equipment, such as a PDCP entity.

In step 901, the user equipment may transmit the information indicative of the current data transmission mode of the data transmission entity of the user equipment to the network equipment based on a predetermined condition.

For example, the information indicative of the current data transmission mode of the data transmission entity of the user equipment may be transmitted to the network equipment according to a predetermined period, which may be set according to actual demands.

For example, the information indicative of the current data transmission mode of the data transmission entity of the user equipment may be transmitted to the network equipment when the data transmission mode of the data transmission entity of the user equipment is changed. For example, when the data transmission mode of the data transmission entity is transformed from a duplication transmission mode to a split transmission mode, or when the data transmission mode of the data transmission entity is transformed from a split transmission mode to a duplication transmission mode, the information indicative of the current data transmission mode of the data transmission entity of the user equipment is transmitted to the network equipment.

In this embodiment, the network equipment may transmit the information in various ways. For example, the information indicative of the current data transmission mode of the data transmission entity of the user equipment may be transmitted to the network equipment via a medium access control layer control element (MAC CE).

For example, the user equipment may transmit the information via a specific MAC CE, such as transmitting the information via a duplication confirmation MAC CE.

In this embodiment, the MAC CE used for transmitting the information may be determined by, for example, a separately defined LCID (logical channel identity) in a subheader in its corresponding MAC PDU.

In this embodiment, similar to Embodiment 1, the MAC CE may indicate, in a bit mapping manner, a current data transmission mode of at least one data transmission entity of the user equipment. For example, a value of at least one bit in a specific field of the MAC CE denotes a current data transmission mode of at least one data transmission entity to which the at least one bit corresponds, such as a duplication transmission mode, or a split transmission mode.

In this embodiment, a structure of the MAC CE may be as shown in FIG. 6, and the MAC CE includes a heading LCD, and a plurality of bits in the specific field respectively correspond to a plurality of PDCP entities of the user equipment taken as data transmitting entities. For example, when a value of a bit is set to be “1”, it indicates that a current data transmission mode of a PDCP entity to which it corresponds is the duplication transmission mode, and when a value of a bit is set to be “0”, it indicates that a current data transmission mode of a PDCP entity to which it corresponds is the split transmission mode.

In this embodiment, the user equipment may also transmit the information indicative of the current data transmission mode of the data transmission entity of the user equipment to the network equipment via a protocol data unit of a packet data convergence protocol (PDCP PDU). For example, a specific field of the PDCP PDU denotes a current data transmission mode of the data transmission entity of the user equipment, such as a duplication transmission mode, or a split transmission mode.

Following description shall be given by taking that a PDCP entity is used as a data transmission entity as an example. For example, a specific field in the PDCP PDU denotes a current data transmission mode of the PDCP entity transmitting the PDCP PDU, such as a duplication transmission mode, or a split transmission mode.

Similar to Embodiment 1, as shown in FIGS. 7 and 8, when a specific field in the PDCP PDU is set to be “1”, it indicates that a current data transmission mode of the PDCP entity transmitting the PDCP PDU is the duplication transmission mode, and when a specific field in the PDCP PDU is set to be “0”, it indicates that a current data transmission mode of the PDCP entity transmitting the PDCP PDU is the split transmission mode.

It can be seen from the above embodiment that by transmitting the confirmation information on an activation command or deactivation command of a duplication transmission mode to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 3

The embodiment of this disclosure provides a confirmation method for an activation command, applicable to a network equipment side. This method corresponds to the processing at the user equipment side in the confirmation method for an activation command in Embodiment 1, with contents identical to those in Embodiment 1 being not going to be described herein any further.

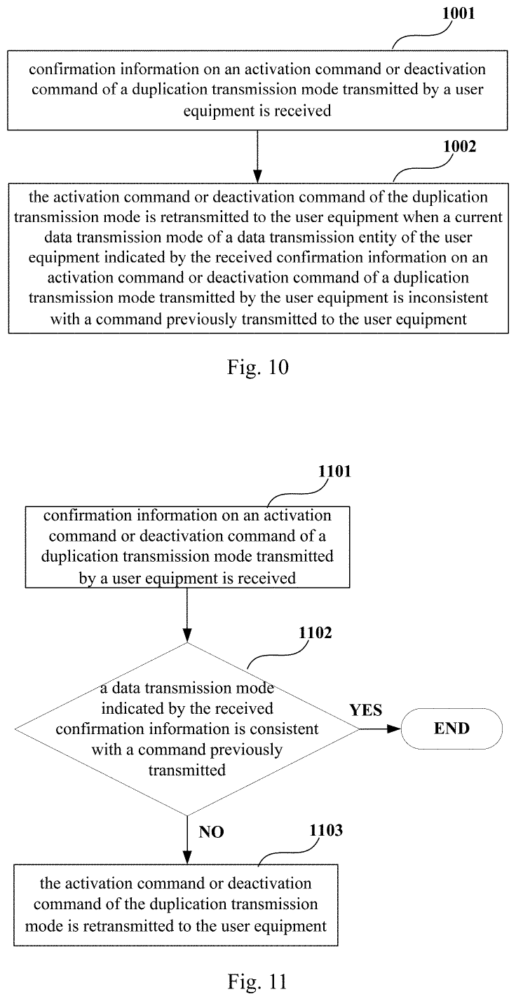

FIG. 10 is a schematic diagram of the confirmation method for an activation command of Embodiment 3 of this disclosure. As shown in FIG. 10, the method includes:

Step 1001: confirmation information on an activation command or deactivation command of a duplication transmission mode transmitted by a user equipment is received.

For example, within a predetermined period of time when an activation command or a deactivation command of a duplication mode is transmitted, the network equipment receives the confirmation information on an activation command or deactivation command of a duplication transmission mode transmitted by the user equipment. In this embodiment, the predetermined time period may be set according to actual demands.

In this embodiment, the method may further include:

Step 1002: the activation command or deactivation command of the duplication transmission mode is retransmitted to the user equipment when a current data transmission mode of a data transmission entity of the user equipment indicated by the received confirmation information on an activation command or deactivation command of a duplication transmission mode transmitted by the user equipment is inconsistent with a command previously transmitted to the user equipment.

For example, when the network equipment previously transmitted an activation command of a duplication transmission mode to the user equipment and received confirmation information indicates that the current data transmission mode of the data transmission entity of the user equipment is the split transmission mode, the network equipment retransmits the activation command of the duplication transmission mode to the user equipment, or when the network equipment previously transmitted a deactivation command of a duplication transmission mode to the user equipment and received confirmation information indicates that the current data transmission mode of the data transmission entity of the user equipment is the duplication transmission mode, the network equipment retransmits the deactivation command of the duplication transmission mode to the user equipment.

FIG. 11 is another schematic diagram of the confirmation method for an activation command of Embodiment 3 of this disclosure. As shown in FIG. 11, the method includes:

Step 1101: confirmation information on an activation command or deactivation command of a duplication transmission mode transmitted by a user equipment is received;

Step 1102: it is determined whether a current data transmission mode of a data transmission entity of the user equipment indicated by the received confirmation information on an activation command or deactivation command of a duplication transmission mode transmitted by the user equipment is consistent with a command previously transmitted to the user equipment, terminating the process when it is determined “yes”, and entering into step 1103 when it is determined “no”; and

Step 1103: the activation command or deactivation command of the duplication transmission mode is retransmitted to the user equipment.

In this way, match of configuration of the transmission modes of the network equipment and the user equipment may be ensured, and reliability of the data transmission and rationality of the resource allocation may also be further ensured.

It can be seen from the above embodiment that by receiving the confirmation information on an activation command or deactivation command of a duplication transmission mode transmitted by the user equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 4

The embodiment of this disclosure provides a confirmation method for an activation command, applicable to a network equipment side. This method corresponds to the processing at the user equipment side in the confirmation method for an activation command in Embodiment 1, with contents identical to those in Embodiment 1 being not going to be described herein any further.

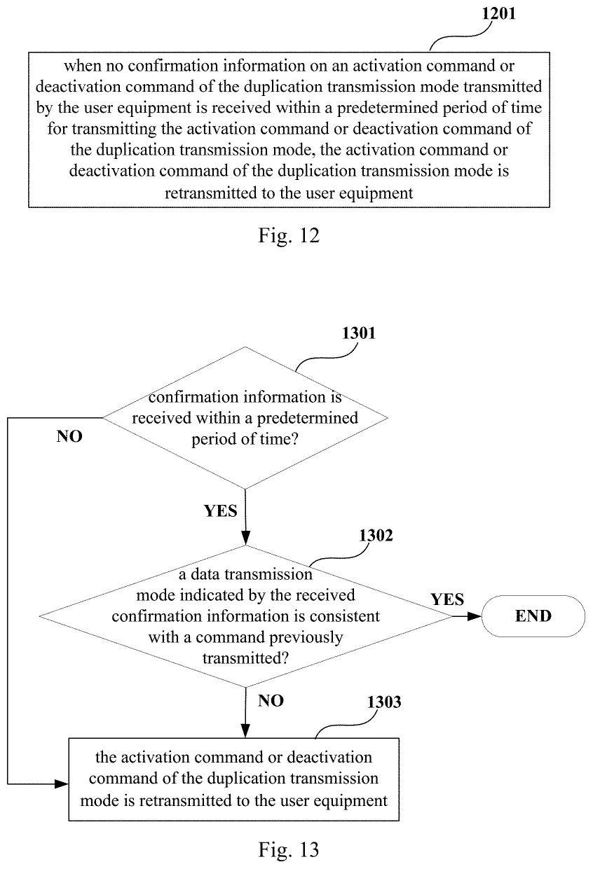

FIG. 12 is a schematic diagram of the confirmation method for an activation command of Embodiment 4 of this disclosure. As shown in FIG. 12, the method includes:

Step 1201: when no confirmation information on an activation command or deactivation command of the duplication transmission mode transmitted by the user equipment is received within a predetermined period of time for transmitting the activation command or deactivation command of the duplication transmission mode, the activation command or deactivation command of the duplication transmission mode is retransmitted to the user equipment.

In this embodiment, the predetermined time period may be set according to actual demands.

It can be seen from the above embodiment that in a case where no confirmation information on an activation command or deactivation command of a duplication transmission mode is received by the network equipment due to some reasons within a predetermined period of time in which an activation command or a deactivation command of a duplication mode is transmitted, the network equipment retransmits the activation command or deactivation command of the duplication transmission mode to the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 5

The embodiment of this disclosure provides a confirmation method for an activation command, applicable to a network equipment side. This method corresponds to the processing at the user equipment side in the confirmation method for an activation command in Embodiment 1, with contents identical to those in Embodiment 1 being not going to be described herein any further.

FIG. 13 is a schematic diagram of the confirmation method for an activation command of Embodiment 5 of this disclosure. As shown in FIG. 13, the method includes:

Step 1301: it is determined whether confirmation information on an activation command or deactivation command of a duplication transmission mode transmitted by a user equipment is received within a predetermined period of time in which the activation command or the deactivation command of the duplication mode is transmitted, entering into step 1302 when it is determined “yes”, and entering into step 1303 when it is determined “no”;

Step 1302: it is determined whether a current data transmission mode of a data transmission entity of the user equipment indicated by the received confirmation information on an activation command or deactivation command of the duplication transmission mode transmitted by the user equipment is consistent with a command previously transmitted to the user equipment, terminating the process when it is determined “yes”, and entering into step 1303 when it is determined “no”; and

Step 1303: the activation command or deactivation command of the duplication transmission mode is retransmitted to the user equipment.

In this embodiment, the predetermined time period may be set according to actual demands.

It can be seen from the above embodiment that by receiving the confirmation information on an activation command or deactivation command of a duplication transmission mode transmitted by the user equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 6

The embodiment of this disclosure provides a confirmation method for an activation command, applicable to a network equipment side and a user equipment side. This method corresponds to the processing at the user equipment side in the confirmation method for an activation command in Embodiment 1 and the processing at the network equipment sides in the confirmation methods for an activation command in embodiments 3-5, with contents identical to those in embodiments 1 and 3-5 being not going to be described herein any further.

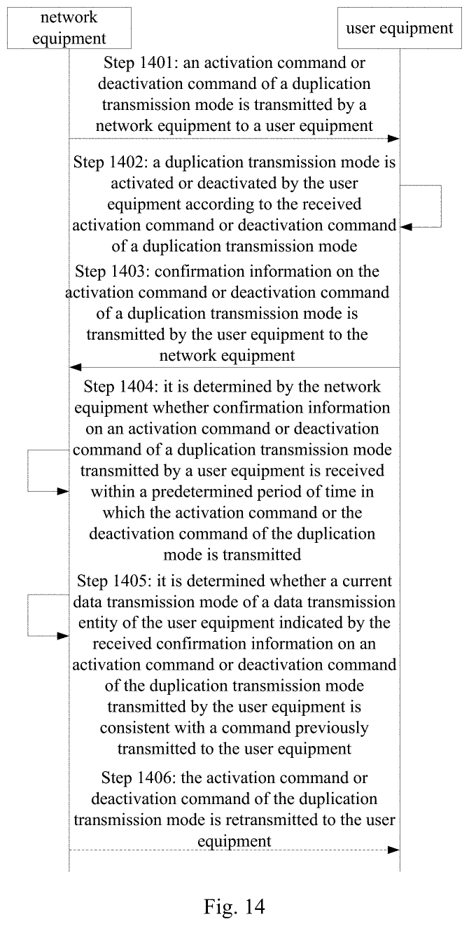

FIG. 14 is a schematic diagram of the confirmation method for an activation command of Embodiment 6 of this disclosure. As shown in FIG. 14, the method includes:

Step 1401: an activation command or deactivation command of a duplication transmission mode is transmitted by a network equipment to a user equipment;

Step 1402: a duplication transmission mode is activated or deactivated by the user equipment according to the received activation command or deactivation command of a duplication transmission mode;

Step 1403: confirmation information on the activation command or deactivation command of a duplication transmission mode is transmitted by the user equipment to the network equipment;

Step 1404: it is determined by the network equipment whether confirmation information on an activation command or deactivation command of a duplication transmission mode transmitted by a user equipment is received within a predetermined period of time in which the activation command or the deactivation command of the duplication mode is transmitted, entering into step 1405 when it is determined “yes”, and entering into step 1406 when it is determined “no”;

Step 1405: it is determined whether a current data transmission mode of a data transmission entity of the user equipment indicated by the received confirmation information on an activation command or deactivation command of the duplication transmission mode transmitted by the user equipment is consistent with a command previously transmitted to the user equipment, terminating the process when it is determined “yes”, and entering into step 1406 when it is determined “no”; and

Step 1406: the activation command or deactivation command of the duplication transmission mode is retransmitted to the user equipment.

It can be seen from the above embodiment that by transmitting the confirmation information on an activation command or deactivation command of a duplication transmission mode to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 7

The embodiment of this disclosure provides a confirmation apparatus for an activation command, corresponding to the confirmation method for an activation command described in Embodiment 1. Reference may be made to the implementation of the confirmation method for an activation command described in Embodiment 1 for implementation of the apparatus, with repeated parts being not going to be described herein any further.

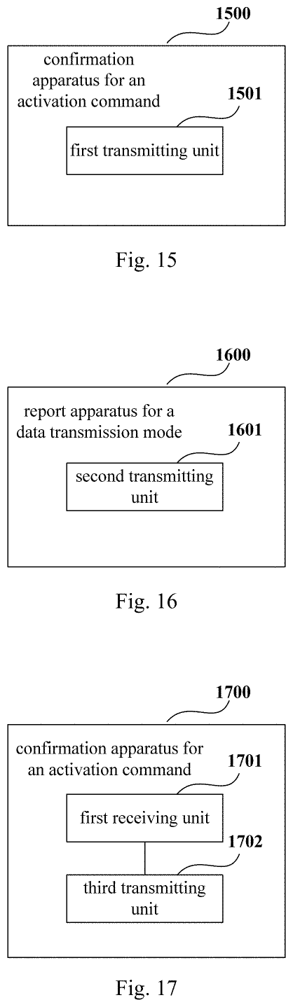

FIG. 15 is a schematic diagram of the confirmation apparatus for an activation command of Embodiment 7 of this disclosure. As shown in FIG. 15, a confirmation apparatus 1500 for an activation command includes:

a first transmitting unit 1501 configured to transmit confirmation information on an activation command or deactivation command of a duplication transmission mode to a network equipment when receiving the activation command or deactivation command of the duplication transmission mode.

In this embodiment, a method for transmitting the confirmation information and particular contents denoted by the confirmation information are identical to those contained Embodiment 1, which shall not be described herein any further.

It can be seen from the above embodiment that by transmitting the confirmation information on an activation command or deactivation command of a duplication transmission mode to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 8

The embodiment of this disclosure provides a report apparatus for a data transmission mode, corresponding to the report method for a data transmission mode described in Embodiment 2. Reference may be made to the implementation of the report method for a data transmission mode described in Embodiment 2 for implementation of the apparatus, with repeated parts being not going to be described herein any further.

FIG. 16 is a schematic diagram of the report apparatus for a data transmission mode of Embodiment 8 of this disclosure. As shown in FIG. 16, a report apparatus 1600 for a data transmission mode includes:

a second transmitting unit 1601 configured to transmit information on a current data transmission mode of a data transmission entity of a user equipment to a network equipment.

In this embodiment, a method for transmitting the information and particular contents denoted by the information are identical to those contained Embodiment 2, which shall not be described herein any further.

It can be seen from the above embodiment that by transmitting the information on the current transmission mode of the data transmission entity of the user equipment to the network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 9

The embodiment of this disclosure provides a confirmation apparatus for an activation command, corresponding to the confirmation method for an activation command described in Embodiment 3. Reference may be made to the implementation of the confirmation method for an activation command described in Embodiment 3 for implementation of the apparatus, with repeated parts being not going to be described herein any further.

FIG. 17 is a schematic diagram of the confirmation apparatus for an activation command of Embodiment 9 of this disclosure. As shown in FIG. 17, a confirmation apparatus 1700 for an activation command includes:

a first receiving unit 1701 configured to receive confirmation information on an activation command or deactivation command of a duplication transmission mode transmitted by a user equipment.

In this embodiment, the apparatus 1700 may further include:

a third transmitting unit 1702 configured to retransmit the activation command or deactivation command of the duplication transmission mode to the user equipment when a current data transmission mode of a data transmission entity of the user equipment indicated by the received confirmation information on an activation command or deactivation command of a duplication transmission mode transmitted by the user equipment is inconsistent with a command previously transmitted to the user equipment.

It can be seen from the above embodiment that by receiving the confirmation information on an activation command or deactivation command of a duplication transmission mode transmitted by the user equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 10

The embodiment of this disclosure provides a confirmation apparatus for an activation command, corresponding to the confirmation method for an activation command described in Embodiment 4. Reference may be made to the implementation of the confirmation method for an activation command described in Embodiment 4 for implementation of the apparatus, with repeated parts being not going to be described herein any further.

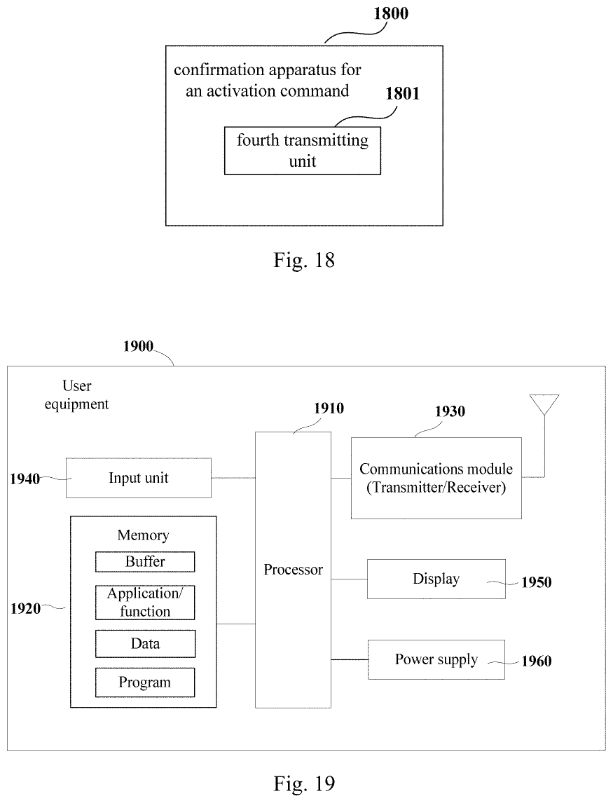

FIG. 18 is a schematic diagram of the confirmation apparatus for an activation command of Embodiment 10 of this disclosure. As shown in FIG. 18, a confirmation apparatus 1800 for an activation command includes:

a fourth transmitting unit 1801 configured to retransmit an activation command or deactivation command of a duplication transmission mode to a user equipment when no confirmation information on an activation command or deactivation command of the duplication transmission mode transmitted by the user equipment is received within a predetermined period of time for transmitting the activation command or deactivation command of the duplication transmission mode.

In this embodiment, the predetermined time period may be set according to actual demands.

It can be seen from the above embodiment that in a case where no confirmation information on an activation command or deactivation command of a duplication transmission mode is received by the network equipment due to some reasons within a predetermined period of time in which an activation command or a deactivation command of a duplication mode is transmitted, the network equipment retransmits the activation command or deactivation command of the duplication transmission mode to the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 11

The embodiment of this disclosure provides a user equipment, including the confirmation apparatus for an activation command described in Embodiment 7.

FIG. 19 is a block diagram of a systematic structure of the user equipment of Embodiment 11 of this disclosure. As shown in FIG. 19, a user equipment 1900 may include a processor 1910 and a memory 1920, the memory 1920 being coupled to the processor 1910. It should be noted that this figure is illustrative only, and other types of structures may also be used, so as to supplement or replace this structure and achieve a telecommunications function or other functions.

In one embodiment, the functions of the confirmation apparatus for an activation command may be integrated into the processor 1910. For example, the processor 1910 may be configured to: transmit confirmation information on an activation command or deactivation command of a duplication transmission mode to a network equipment when receiving the activation command or deactivation command of a duplication transmission mode.

For example, the transmitting confirmation information on an activation command or deactivation command of a duplication transmission mode to a network equipment includes: transmitting the confirmation information on the activation command or deactivation command of the duplication transmission mode to the network equipment via a medium access control layer control element (MAC CE).

For example, the confirmation information on the activation command or deactivation command of the duplication transmission mode is transmitted to the network equipment via a duplication confirmation MAC CE.

For example, the medium access control layer control element denotes that a user equipment receives the activation command or deactivation command of the duplication transmission mode.

For example, the medium access control layer control element denotes in a bit mapping manner whether at least one data transmission entity of the UE is successfully activated or deactivated with a duplication transmission mode, or denotes a current data transmission mode of at least one data transmission entity of the UE.

For example, a value of at least one bit in a specific field of the medium access control layer control element denotes whether at least one data transmission entity of the UE to which the at least one bit corresponds is successfully activated or deactivated with the duplication transmission mode, or denotes whether a current data transmission mode of at least one data transmission entity of the UE to which the at least one bit corresponds is a duplication transmission mode or a split transmission mode.

For example, the transmitting confirmation information on an activation command or deactivation command of a duplication transmission mode to a network equipment includes: transmitting the confirmation information on the activation command or deactivation command of the duplication transmission mode to the network equipment via a protocol data unit of a packet data convergence protocol.

For example, a specific field of the protocol data unit of the packet data convergence protocol denotes whether a data transmission entity of UE is successfully activated or deactivated with a duplication transmission mode, or denotes whether a current data transmission mode of a data transmission entity of UE is a duplication transmission mode or a split transmission mode.

In another embodiment, the confirmation apparatus for an activation command and the processor 1910 may be configured separately. For example, the confirmation apparatus for an activation command may be configured as a chip connected to the processor 1910, with its functions being realized under control of the processor 1910.

As shown in FIG. 19, the user equipment 1900 may further include a communications module 1930, an input unit 1940, a display 1950, and a power supply 1960. It should be noted that the user equipment 1900 does not necessarily include all the parts shown in FIG. 19, and the above components are not necessary; and furthermore, the user equipment 1900 may include parts not shown in FIG. 19, and the related art may be referred to.

As shown in FIG. 19, the processor 1910 is sometimes referred to as a controller or control, which may include a microprocessor or other processor devices and/or logic devices, and the processor 1910 receives input and controls operations of every component of the user equipment 1900.

The memory 1920 may be, for example, one or more of a buffer memory, a flash memory, a hard drive, a mobile medium, a volatile memory, a nonvolatile memory, or other suitable devices, which may store the information on configuration, and furthermore, store programs executing related information. And the processor 1910 may execute programs stored in the memory 1920, so as to realize information storage or processing, etc. Functions of other parts are similar to those of the related art, which shall not be described herein any further. The parts of the user equipment 1900 may be realized by specific hardware, firmware, software, or any combination thereof, without departing from the scope of this disclosure.

It can be seen from the above embodiment that by transmitting the confirmation information on an activation command or deactivation command of a duplication transmission mode to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 12

The embodiment of this disclosure provides a user equipment, including the report apparatus for a data transmission mode described in Embodiment 8.

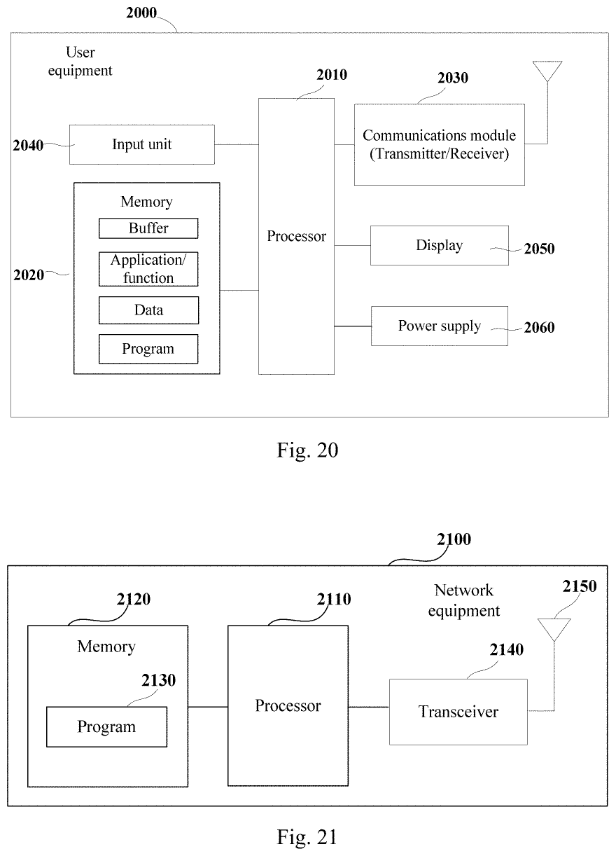

FIG. 20 is a block diagram of a systematic structure of the user equipment of Embodiment 12 of this disclosure. As shown in FIG. 20, a user equipment 2000 may include a processor 2010 and a memory 2020, the memory 2020 being coupled to the processor 2010. It should be noted that this figure is illustrative only, and other types of structures may also be used, so as to supplement or replace this structure and achieve a telecommunications function or other functions.

In one embodiment, the functions of the report apparatus for a data transmission mode may be integrated into the processor 2010. For example, the processor 2010 may be configured to: transmit information on a current data transmission mode of a data transmission entity of a user equipment to a network equipment.

For example, the transmitting information on a current data transmission mode of a data transmission entity of a user equipment to a network equipment includes: transmitting the information on a current data transmission mode of a data transmission entity of UE to the network equipment according to a predetermined period, or transmitting the information on a current data transmission mode of a data transmission entity of UE to the network equipment when a data transmission mode of the data transmission entity of the UE is changed.

For example, the transmitting information on a current data transmission mode of a data transmission entity of a user equipment to a network equipment includes: transmitting the information on a current data transmission mode of a data transmission entity of UE to the network equipment via a medium access control layer control element (MAC CE).

For example, the information on a current data transmission mode of a data transmission entity of UE is transmitted to the network equipment via a duplication confirmation MAC CE.

For example, the medium access control layer control element denotes in a bit mapping manner a current data transmission mode of the at least one data transmission entity.

For example, a value of at least one bit in a specific field of the medium access control layer control element denotes a current data transmission mode of at least one data transmission entity to which the at least one bit corresponds.

For example, the transmitting information on a current data transmission mode of a data transmission entity of a user equipment to a network equipment includes: transmitting the information denoting a current data transmission mode of a data transmission entity of the user equipment to the network equipment via a protocol data unit of a packet data convergence protocol.

For example, a specific field of the protocol data unit of the packet data convergence protocol denotes a current data transmission mode of the data transmission entity.

For example, the data transmission mode is a duplication transmission mode or a split transmission mode.

In another embodiment, the report apparatus for a data transmission mode and the processor 2010 may be configured separately. For example, the report apparatus for a data transmission mode may be configured as a chip connected to the processor 2010, with its functions being realized under control of the processor 2010.

As shown in FIG. 20, the user equipment 2000 may further include a communications module 2030, an input unit 2040, a display 2050, and a power supply 2060. It should be noted that the user equipment 2000 does not necessarily include all the parts shown in FIG. 20, and the above components are not necessary; and furthermore, the user equipment 2000 may include parts not shown in FIG. 20, and the related art may be referred to.

As shown in FIG. 20, the processor 2010 is sometimes referred to as a controller or control, which may include a microprocessor or other processor devices and/or logic devices, and the processor 2010 receives input and controls operations of every component of the user equipment 2000.

The memory 2020 may be, for example, one or more of a buffer memory, a flash memory, a hard drive, a mobile medium, a volatile memory, a nonvolatile memory, or other suitable devices, which may store the information on configuration, and furthermore, store programs executing related information. And the processor 2010 may execute programs stored in the memory 2020, so as to realize information storage or processing, etc. Functions of other parts are similar to those of the related art, which shall not be described herein any further. The parts of the user equipment 2000 may be realized by specific hardware, firmware, software, or any combination thereof, without departing from the scope of this disclosure.

It can be seen from the above embodiment that by transmitting the confirmation information on an activation command or deactivation command of a duplication transmission mode to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 13

The embodiment of this disclosure provides a network equipment, including the confirmation apparatus for an activation command described in Embodiment 9.

FIG. 21 is a block diagram of a systematic structure of the network equipment of Embodiment 13 of this disclosure. As shown in FIG. 21, a network equipment 2100 may include a processor 2110 and a memory 2120, the memory 2120 being coupled to the processor 2110. For example, the memory 2120 may store various data, and furthermore, it may store a program 2130 for data processing, and execute the program 2130 under control of the processor 2110, so as to receive various information transmitted by a user equipment, and transmit various information to the user equipment.

In one embodiment, the functions of the confirmation apparatus for an activation command may be integrated into the processor 2110. For example, the processor 2110 may be configured to: receive confirmation information on an activation command or deactivation command of a duplication transmission mode transmitted by a user equipment.

For example, the processor 2110 may further be configured to: retransmit the activation command or deactivation command of the duplication transmission mode to the user equipment when a current data transmission mode of a data transmission entity of the user equipment indicated by the received confirmation information on an activation command or deactivation command of a duplication transmission mode transmitted by the user equipment is inconsistent with a command previously transmitted to the user equipment.

In another embodiment, the confirmation apparatus for an activation command and the central processor 2110 may be configured separately. For example, the confirmation apparatus for an activation command may be configured as a chip connected to the processor 2110, with its functions being realized under control of the processor 2110.

Furthermore, as shown in FIG. 21, the network equipment 2100 may include a transceiver 2140, and an antenna 2150, etc. Functions of the above components are similar to those in the related art, and shall not be described herein any further. It should be noted that the network equipment 2100 does not necessarily include all the parts shown in FIG. 21, and furthermore, the network equipment 2100 may include parts not shown in FIG. 21, and the related art may be referred to.

It can be seen from the above embodiment that by receiving the confirmation information on an activation command or deactivation command of a duplication transmission mode transmitted by the user equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 14

The embodiment of this disclosure provides a network equipment, including the confirmation apparatus for an activation command described in Embodiment 10.

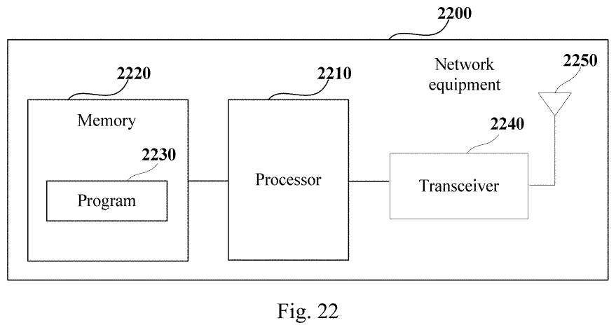

FIG. 22 is a block diagram of a systematic structure of the network equipment of Embodiment 14 of this disclosure. As shown in FIG. 22, a network equipment 2200 may include a processor 2210 and a memory 2220, the memory 2220 being coupled to the processor 2210. For example, the memory 2220 may store various data, and furthermore, it may store a program 2230 for data processing, and execute the program 2230 under control of the processor 2210, so as to receive various information transmitted by a user equipment, and transmit various information to the user equipment.

In one embodiment, the functions of the confirmation apparatus for an activation command may be integrated into the processor 2210. For example, the processor 2210 may be configured to: retransmit an activation command or deactivation command of a duplication transmission mode to a user equipment when no confirmation information on an activation command or deactivation command of the duplication transmission mode transmitted by the user equipment is received within a predetermined period of time for transmitting the activation command or deactivation command of the duplication transmission mode.

In another embodiment, the confirmation apparatus for an activation command and the central processor 2210 may be configured separately. For example, the confirmation apparatus for an activation command may be configured as a chip connected to the processor 2210, with its functions being realized under control of the processor 2210.

Furthermore, as shown in FIG. 22, the network equipment 2200 may include a transceiver 2240, and an antenna 2250, etc. Functions of the above components are similar to those in the related art, and shall not be described herein any further. It should be noted that the network equipment 2200 does not necessarily include all the parts shown in FIG. 22, and furthermore, the network equipment 2200 may include parts not shown in FIG. 22, and the related art may be referred to.

It can be seen from the above embodiment that in a case where no confirmation information on an activation command or deactivation command of a duplication transmission mode is received by the network equipment due to some reasons within a predetermined period of time in which an activation command or a deactivation command of a duplication mode is transmitted, the network equipment retransmits the activation command or deactivation command of the duplication transmission mode to the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

### Embodiment 15

The embodiment of this disclosure provides a communications system, including the user equipment described in Embodiment 11 and the network equipment described in Embodiment 13 or Embodiment 14. For example, reference may be made to FIG. 1 for a structure of the communications system. As shown in FIG. 1, the communications system 100 includes a network equipment 101 and a user equipment 102, a structure and functions of the network equipment 101 being as described in Embodiment 13 or Embodiment 14, and a structure and functions of the user equipment 102 being as described in Embodiment 11, which shall not be described herein any further.

It can be seen from the above embodiment that by transmitting the confirmation information on an activation command or deactivation command of a duplication transmission mode to network equipment, the network equipment is able to confirm the current data transmission mode of the data transmission entity of the user equipment, thereby ensuring match of configuration of the transmission modes of the network equipment and the user equipment, avoiding misunderstanding of the buffer status report of the user equipment by the network equipment, and ensuring reliability of the data transmission and rationality of the resource allocation.

The above apparatuses and methods of this disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 15 may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communications combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

For embodiments of this disclosure containing the above embodiments, following supplements are further disclosed.

Supplement 1. A confirmation apparatus for an activation command, including:

a first transmitting unit configured to transmit confirmation information on an activation command or deactivation command of a duplication transmission mode to a network equipment when receiving the activation command or deactivation command of the duplication transmission mode.

Supplement 2. The apparatus according to supplement 1, wherein,

the first transmitting unit is configured to transmit the confirmation information on the activation command or deactivation command of the duplication transmission mode to the network equipment via a medium access control layer control element (MAC CE).

Supplement 3. The apparatus according to supplement 2, wherein,

the first transmitting unit is configured to transmit the confirmation information on the activation command or deactivation command of the duplication transmission mode to the network equipment via a duplication confirmation MAC CE.

Supplement 4. The apparatus according to supplement 2, wherein,

the medium access control layer control element denotes that a user equipment receives the activation command or deactivation command of the duplication transmission mode.

Supplement 5. The apparatus according to supplement 2, wherein,

the medium access control layer control element denotes in a bit mapping manner whether at least one data transmission entity of the user equipment is successfully activated or deactivated with a duplication transmission mode, or denotes a current data transmission mode of at least one data transmission entity of the user equipment.

Supplement 6. The apparatus according to supplement 5, wherein,

a value of at least one bit in a specific field of the medium access control layer control element denotes whether at least one data transmission entity of the user equipment to which the at least one bit corresponds is successfully activated or deactivated with the duplication transmission mode, or denotes whether a current data transmission mode of at least one data transmission entity of the user equipment to which the at least one bit corresponds is a duplication transmission mode or a split transmission mode.

Supplement 7. The apparatus according to supplement 1, wherein,

the first transmitting unit is configured to transmit the confirmation information on the activation command or deactivation command of the duplication transmission mode to the network equipment via a protocol data unit of a packet data convergence protocol.

Supplement 8. The apparatus according to supplement 7, wherein,

a specific field of the protocol data unit of the packet data convergence protocol denotes whether a data transmission entity of a user equipment is successfully activated or deactivated with a duplication transmission mode, or denotes whether a current data transmission mode of a data transmission entity of a user equipment is a duplication transmission mode or a split transmission mode.

Supplement 9. A report apparatus for a data transmission mode, including:

a second transmitting unit configured to transmit information on a current data transmission mode of a data transmission entity of a user equipment (UE) to a network equipment.

Supplement 10. The apparatus according to supplement 9, wherein,

the second transmitting unit is configured to transmit the information on a current data transmission mode of a data transmission entity of a user equipment to the network equipment according to a predetermined period, or

the second transmitting unit is configured to transmit the information on a current data transmission mode of a data transmission entity of a user equipment to the network equipment when a data transmission mode of the data transmission entity of the user equipment is changed.

Supplement 11. The apparatus according to supplement 9, wherein,

the second transmitting unit is configured to transmit the information on a current data transmission mode of a data transmission entity of a user equipment to the network equipment via a medium access control layer control element (MAC CE).

Supplement 12. The apparatus according to supplement 11, wherein,

the second transmitting unit is configured to transmit the information on a current data transmission mode of a data transmission entity of a user equipment to the network equipment via a duplication confirmation MAC CE.

Supplement 13. The apparatus according to supplement 11, wherein,

the MAC CE denotes in a bit mapping manner a current data transmission mode of the at least one data transmission entity.

Supplement 14. The apparatus according to supplement 13, wherein,

a value of at least one bit in a specific field of the MAC CE denotes a current data transmission mode of at least one data transmission entity to which the at least one bit corresponds.

Supplement 15. The apparatus according to supplement 9, wherein,

the second transmitting unit is configured to transmit the information denoting a current data transmission mode of a data transmission entity of a user equipment to the network equipment via a protocol data unit of a packet data convergence protocol.

Supplement 16. The apparatus according to supplement 15, wherein,

a specific field of the protocol data unit of the packet data convergence protocol denotes a current data transmission mode of the data transmission entity.

Supplement 17. The apparatus according to any one of supplements 9-16, wherein the data transmission mode is a duplication transmission mode or a split transmission mode.

Supplement 18. A user equipment, including the confirmation apparatus for an activation command as described in supplement 1 or the report apparatus for a data transmission mode as described in supplement 9.

Supplement 19. A confirmation apparatus for an activation command, including:

a first receiving unit configured to receive confirmation information on an activation command or deactivation command of a duplication transmission mode transmitted by a user equipment.

Supplement 20. The apparatus according to supplement 19, wherein the apparatus further includes:

a third transmitting unit configured to retransmit the activation command or deactivation command of the duplication transmission mode to the user equipment when a current data transmission mode of a data transmission entity of the user equipment indicated by the received confirmation information on an activation command or deactivation command of a duplication transmission mode transmitted by the user equipment is inconsistent with a command previously transmitted to the user equipment.

Supplement 21. A confirmation apparatus for an activation command, including:

a fourth transmitting unit configured to retransmit an activation command or deactivation command of a duplication transmission mode to a user equipment when no confirmation information on an activation command or deactivation command of the duplication transmission mode transmitted by the user equipment is received within a predetermined period of time for transmitting the activation command or deactivation command of the duplication transmission mode.

Supplement 22. A network equipment, including the confirmation apparatus for an activation command as described in supplement 19 or 21.

Supplement 23. A communications system, including the user equipment as described in supplement 18 and the network equipment as described in supplement 22.

Supplement 24. A confirmation method for an activation command, including:

transmitting confirmation information on an activation command or deactivation command of a duplication transmission mode to a network equipment when receiving the activation command or deactivation command of the duplication transmission mode. Supplement 25. The method according to supplement 24, wherein the transmitting confirmation information on an activation command or deactivation command of a duplication transmission mode to a network equipment includes:

transmitting the confirmation information on the activation command or deactivation command of the duplication transmission mode to the network equipment via a medium access control layer control element (MAC CE).

Supplement 26. The method according to supplement 25, wherein,

the confirmation information on the activation command or deactivation command of the duplication transmission mode is transmitted to the network equipment via a duplication confirmation MAC CE.

Supplement 27. The method according to supplement 25, wherein,

the medium access control layer control element denotes that a user equipment receives the activation command or deactivation command of the duplication transmission mode.

Supplement 28. The method according to supplement 25, wherein,

the medium access control layer control element denotes in a bit mapping manner whether at least one data transmission entity of the user equipment is successfully activated or deactivated with a duplication transmission mode, or denotes a current data transmission mode of at least one data transmission entity of the user equipment.

Supplement 29. The method according to supplement 28, wherein,

a value of at least one bit in a specific field of the medium access control layer control element denotes whether at least one data transmission entity of the user equipment to which the at least one bit corresponds is successfully activated or deactivated with the duplication transmission mode, or denotes whether a current data transmission mode of at least one data transmission entity of the user equipment to which the at least one bit corresponds is a duplication transmission mode or a split transmission mode.

Supplement 30. The method according to supplement 24, wherein the transmitting confirmation information on an activation command or deactivation command of a duplication transmission mode to a network equipment includes:

transmitting the confirmation information on the activation command or deactivation command of the duplication transmission mode to the network equipment via a protocol data unit of a packet data convergence protocol.

Supplement 31. The method according to supplement 30, wherein,

a specific field of the protocol data unit of the packet data convergence protocol denotes whether a data transmission entity of a user equipment is successfully activated or deactivated with a duplication transmission mode, or denotes whether a current data transmission mode of a data transmission entity of a user equipment is a duplication transmission mode or a split transmission mode.

Supplement 32. A report method for a data transmission mode, including:

transmitting information on a current data transmission mode of a data transmission entity of a user equipment to a network equipment.

Supplement 33. The method according to supplement 32, wherein the transmitting information on a current data transmission mode of a data transmission entity of a user equipment to a network equipment includes:

transmitting the information on a current data transmission mode of a data transmission entity of UE to the network equipment according to a predetermined period, or

transmitting the information on a current data transmission mode of a data transmission entity of UE to the network equipment when a data transmission mode of the data transmission entity of the UE is changed.

Supplement 34. The method according to supplement 32, wherein the transmitting information on a current data transmission mode of a data transmission entity of a user equipment to a network equipment includes:

transmitting the information on a current data transmission mode of a data transmission entity of UE to the network equipment via a medium access control layer control element (MAC CE).

Supplement 35. The method according to supplement 34, wherein,

the information on a current data transmission mode of a data transmission entity of UE is transmitted to the network equipment via a duplication confirmation MAC CE.

Supplement 36. The method according to supplement 34, wherein,

the medium access control layer control element denotes in a bit mapping manner a current data transmission mode of the at least one data transmission entity.

Supplement 37. The method according to supplement 36, wherein,

a value of at least one bit in a specific field of the medium access control layer control element denotes a current data transmission mode of at least one data transmission entity to which the at least one bit corresponds.

Supplement 38. The method according to supplement 32, wherein the transmitting information on a current data transmission mode of a data transmission entity of a user equipment to a network equipment includes:

transmitting the information denoting a current data transmission mode of a data transmission entity of the user equipment to the network equipment via a protocol data unit of a packet data convergence protocol.

Supplement 39. The method according to supplement 38, wherein,

a specific field of the protocol data unit of the packet data convergence protocol denotes a current data transmission mode of the data transmission entity.

Supplement 40. The method according to any one of supplements 32-39, wherein,

the data transmission mode is a duplication transmission mode or a split transmission mode.

Supplement 41. A confirmation method for an activation command, including:

receiving confirmation information on an activation command or deactivation command of a duplication transmission mode transmitted by a user equipment.

Supplement 42. The method according to supplement 41, wherein the method further includes:

retransmitting the activation command or deactivation command of the duplication transmission mode to the user equipment when a current data transmission mode of a data transmission entity of the user equipment indicated by the received confirmation information on an activation command or deactivation command of a duplication transmission mode transmitted by the user equipment is inconsistent with a command previously transmitted to the user equipment.

Supplement 43. A confirmation method for an activation command, including:

retransmitting an activation command or deactivation command of a duplication transmission mode to a user equipment when no confirmation information on an activation command or deactivation command of the duplication transmission mode transmitted by the user equipment is received within a predetermined period of time for transmitting the activation command or deactivation command of the duplication transmission mode.

What is claimed is:

1. A confirmation apparatus for an activation command, comprising:
a first transmitting unit configured to transmit confirmation information on an activation command or deactivation command of a duplication transmission mode to a network equipment when receiving the activation command or deactivation command of the duplication transmission mode.

2. The apparatus according to claim 1, wherein,
the first transmitting unit is configured to transmit the confirmation information on the activation command or deactivation command of the duplication transmission mode to the network equipment via a medium access control layer control element (MAC CE).

3. The apparatus according to claim 2, wherein,
the first transmitting unit is configured to transmit the confirmation information on the activation command or deactivation command of the duplication transmission mode to the network equipment via a duplication confirmation MAC CE.

4. The apparatus according to claim 2, wherein,
the MAC CE denotes that a user equipment (UE) receives the activation command or deactivation command of the duplication transmission mode.

5. The apparatus according to claim 2, wherein,
the MAC CE denotes in a bit mapping manner whether at least one data transmission entity of the UE is successfully activated or deactivated with a duplication transmission mode, or denotes a current data transmission mode of at least one data transmission entity of the UE.

6. The apparatus according to claim 5, wherein,
a value of at least one bit in a specific field of the MAC CE denotes whether at least one data transmission entity of the UE to which the at least one bit corresponds is successfully activated or deactivated with the duplication transmission mode, or denotes whether a current data transmission mode of at least one data transmission entity of the UE to which the at least one bit corresponds is a duplication transmission mode or a split transmission mode.

7. The apparatus according to claim 1, wherein,
the first transmitting unit is configured to transmit the confirmation information on the activation command or deactivation command of the duplication transmission mode to the network equipment via a protocol data unit (PDU) of a packet data convergence protocol (PDCP).

8. The apparatus according to claim 7, wherein,
a specific field of the protocol data unit of the packet data convergence protocol denotes whether a data transmission entity of a UE is successfully activated or deactivated with a duplication transmission mode, or denotes whether a current data transmission mode of a data transmission entity of a UE is a duplication transmission mode or a split transmission mode.

9. A report apparatus for a data transmission mode, comprising:
a second transmitting unit configured to transmit information on a current data transmission mode of a data transmission entity of a user equipment (UE) to a network equipment.

10. The apparatus according to claim 9, wherein,
the second transmitting unit is configured to transmit the information on a current data transmission mode of a data transmission entity of a UE to the network equipment according to a predetermined period, or
the second transmitting unit is configured to transmit the information on a current data transmission mode of a data transmission entity of a UE to the network equipment when a data transmission mode of the data transmission entity of the UE is changed.

11. The apparatus according to claim 9, wherein,
the second transmitting unit is configured to transmit the information on a current data transmission mode of a data transmission entity of a UE to the network equipment via a medium access control layer control element (MAC CE).

12. The apparatus according to claim 11, wherein,
the second transmitting unit is configured to transmit the information on a current data transmission mode of a data transmission entity of a UE to the network equipment via a duplication confirmation MAC CE.

13. The apparatus according to claim 11, wherein,
the MAC CE denotes in a bit mapping manner a current data transmission mode of the at least one data transmission entity.

14. The apparatus according to claim 13, wherein,
a value of at least one bit in a specific field of the MAC CE denotes a current data transmission mode of at least one data transmission entity to which the at least one bit corresponds.

15. The apparatus according to claim 9, wherein,
the second transmitting unit is configured to transmit the information denoting a current data transmission mode of a data transmission entity of a UE to the network equipment via a protocol data unit (PDU) of a packet data convergence protocol (PDCP).

16. The apparatus according to claim 15, wherein,
a specific field of the protocol data unit of the packet data convergence protocol denotes a current data transmission mode of the data transmission entity.

17. The apparatus according to claim 9, wherein the data transmission mode is a duplication transmission mode or a split transmission mode.

18. A user equipment, comprising the confirmation apparatus for an activation command as claimed in claim 1.

19. A user equipment, comprising the report apparatus for a data transmission mode as claimed in claim 9.
